(19) United States
(12) Patent Application Publication
(10) Pub. No.: US 2005/0097069 A1
(43) Pub. Date: May 5, 2005

(54) Method of choosing tester designs and use model using operating characteristics

(76) Inventors: Jonathan Qiang Li, Mountain View, CA (US); Lee A. Barford, San Jose, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/699,542

(22) Filed: Oct. 31, 2003

(51) Int. Cl. G06G 7/00; G06F 15/18; G06N 5/02; G06F 17/00

(52) U.S. Cl. 706/46; 706/19

(57) ABSTRACT

Optimizing tester performance using Operating Characteristics curves. By modeling the Operating Characteristics of classifiers used in testing systems, tester performance is optimized. Classifiers are constructed using sample data. Operating Characteristic curves for each classifier are constructed, each Operating Characteristics curve representing a design alternative. The Operating Characteristic curves are combined with cost models from which design decisions may be made.

### CROSS REFERENCE TO RELATED APPLICATIONS

The present application is related to co-pending and commonly owned U.S. patent application Ser. No. 10/132,626 entitled “Classification of Rare Events with High Reliability filed Apr. 25, 2002, the disclosure of which is incorporated herein by reference.

### BACKGROUND OF THE INVENTION

1. Field of the Invention

The present invention pertains to the art of designing testers and test methodologies. More particularly, it pertains to the design of testers and test methodologies using classification systems.

2. Art Background

Testing systems are widely used. They are called upon to measure or observe properties of an object or device under test, and produce one or more categorical information about the object or device being tested. Examples of such testers include the testing of electronic products during manufacturing, security screening at airports, food or drug safety tests, and other tests that involve pass and failure decisions for the test performed. The medium used in the tester may be electrical, chemical, or physical. In each case, the purpose of the tester is to measure or observe properties or variables of something being tested (called a device or system under test, or DUT) and produce one or more pieces of categorical information about the DUT, such as whether the DUT is good or bad or whether various subsystems or subcomponents of the DUT are good or bad, or whether or not the DUT being tested requires further testing, such as hand inspection in a screening environment.

The customer using the tester desires this categorical information, not the values of the various measurements required to extract the categorical information.

As a more specific example, consider the manufacturing of Printed Circuit Boards (PCBs) used in electronics products. During each stage of manufacture various defects can occur that cause the PCB to malfunction. Automated X-ray inspection using X-ray imaging is used for testing whether or not solder joints are properly formed on the PCB. In-circuit test using electrical probes is used to test whether circuits on the PCB are formed and functioning correctly.

Traditionally, testers are designed first as computer-controlled measurement systems, systems that sense the DUT and obtain various numerical values corresponding to physical parameters measured. All measurements are taken at some high level of precision, repeatability, and accuracy. This is because it is naturally presumed that a high level of measurement precision, repeatability, and accuracy will lead to highly accurate tests. During operation of the tester, the values measured for a particular DUT are fed into some kind of computer-based decision procedure or algorithm which selects categorical information to output based on the measured values and various other tuning parameters or thresholds input to the algorithm. It is up to the designer of this algorithm and to those who select the parameters and thresholds to determine how to produce accurate categorical information from the measured values.

While this methodology for tester design, that of designing testers as measurement systems, has been satisfactory for some time, it is becoming increasingly less so for a variety of reasons. It results in a more expensive product than necessary because all measurements must be highly repeatable, accurate, and precise even if they have less bearing on the desired categorical outputs. It may result in a longer time-to-market for the tester, because means for producing the highly repeatable, accurate, and precise measurements must be devised. There is no principled manner of determining which measurements may be made with less precision, or not at all, while achieving the desired level of tester accuracy (i.e. the accuracy of the categorical information output). In some areas, such as electronics manufacturing, the number of DUTs (e.g. electrical connections in a product) increase greatly over time, placing excessive burdens on test engineers to select the required tuning parameters, models, or thresholds for testing all of these connections.

### SUMMARY OF THE INVENTION

By modeling the Operating Characteristics of classifiers used in testing systems, tester performance is optimized. Classifiers for design alternatives are produced from test data. Operating Characteristic curves are produced from the classifiers for each design alternative, and combined with cost models from which design decisions may be made.

### BRIEF DESCRIPTION OF THE DRAWINGS

The present invention is described with respect to particular exemplary embodiments thereof and reference is made to the drawings in which:

FIG. 1 shows a flowchart of the present invention.

### DETAILED DESCRIPTION

The present invention provides a methodology for designing testers that is focused first and primarily on their performance as testers, and not as measurement systems. The focus is on performance as testers, i.e. as extractors of categorical information (e.g. good vs. bad).

The effectiveness of a tester is ultimately determined by two key performance measures: its ability to catch the true defects, and its ability to avoid falsely calling something defective. The former is characterized by fault coverage or sensitivity. The later is characterized by the false call rate. An effective tester has high sensitivity and low false call rate.

High sensitivity is desired. In manufacturing test for example, production can be divided into many stages. Testing is often conducted at each stage of manufacturing. Missed defects at one stage must be detected and fixed at subsequent stages of production. The economic cost of fixing a defect normally increases by an order of magnitude as the product moves to the next stage of manufacturing. If a defect moves into the assembled final product, the cost and liability of fixing a customer problem can be unpredictably high.

A low false call rate, the rate at which a good product is identified as defective, is equally desired. In the manufacturing process, a defect call by the tester usually means pulling the product off the line, going through manual inspection, and moving the product through repair stations. This process is expensive and time consuming. Furthermore, sending a normally operating product through this process increases the chance of causing defects inadvertently.

Statistical Classification is used to mathematically quantify the relationship between sensitivity and false call rate. A statistical classifier is built by learning from examples. After being presented with many samples of good items and defective items, the classifier forms a mathematical hypothesis to tell a defective item from a good one. Such a mathematical hypothesis is normally embodied by a decision function that takes features of the sample item as input, and outputs the decision. The decisions are often binary—“good” or “bad”—but the decisions can also be multi-category, for example, “good,” “bad,” or “in doubt,” or separating an item into performance grades Advanced classifiers may be hierarchical in nature, using a first stage to remove members of a first majority class, and using subsequent stages to discriminate between minority class members and the remaining majority class members which have passed through the first stage of classification.

The performance of a classifier can be quantified and visualized as an Operating Characteristics curve. An operating point is a tunable parameter in the classifier which alters the respective performance of sensitivity and false call rate. As one “tunes up” the sensitivity, the false call rate will inevitably go up as well. An Operating Characteristics curve is formed by varying the operating point, and measures the sensitivity and false call rate at each point using the technique of Cross Validation. The Operating Characteristics curve gives a visual indication of the trade-off between sensitivity and false call rate. It also demonstrates the asymptotic property of a classifier, i.e. how far the classifier is from an ideal classifier with 100% sensitivity and 0% false call rate.

The performance of a Statistical Classifier is the result of combined components in the tester. These components typically include data acquisition, data processing, and classification. In an automated X-ray inspection system for example, data acquisition includes the X-ray source, X-ray detectors, and related circuits. Data processing consists primarily of calibrating the X-ray source and detection systems, image processing including feature extraction, or 3-D reconstruction if 3-D imaging is required. Classification is the final computer-based step which takes the output from all previous systems and makes decisions on the inspected object.

Often times improvement in one aspect of a tester can result in a performance improvement of the tester overall. A good example is in imaging-based testers; a higher resolution in image data acquisition often produces better classification results. On the other hand, combined effects of various component or subsystem improvements introduce much greater increases in overall tester performance. For example, image processing algorithms coupled with special imaging geometry design results in much better tester performance than is achieved by optimizing only one of these components. Thus, the Operating Characteristics curve of a classifier provides a characterization of not only the classifier, but also of the tester as a whole.

Using such a characterization, comparisons may be made between different embodiments of tester design schemes. If one tester has a uniformly higher Operating Characteristics curve than another, it can often be considered as a better tester. If competing designs have curves which intersect, or when accuracy is not the only concern of the tester, other factors can be combined with Operating Characteristics curves to make a choice. Such factors typically include throughput and cost. Both these factors are typically studied in great detail in making design decisions. The throughput of a tester is often limited by factors such as the rate at which data acquisition occurs, and by the speed at which the resulting data is processed. The cost of a tester is determined by the costs of its component parts.

Secondly, using Operating Characteristics it is possible to pick optimal operating points for the tester use model in different modes of operation. When a tester is operated on a manufacturing line, it can be tuned to meet specific requirements for false call rate and sensitivity. When costs of false call and false pass can be given quantitatively, Operating Characteristics curves can be used to optimize the overall economic cost of the test, picking the point on the Operating Characteristics curve which minimizes the economic cost. When costs are unknown, Operating Characteristics curves can also be used to optimize the overall misclassification rate. When the tolerance level on sensitivity is given in a specific application, Operating Characteristics curves can be used to minimize the respective false call rate by moving down the flat section of the Operating Characteristics curves.

According to the present invention, using the OC curve provides a better metric which helps tester designers have a more complete understanding of tester characteristics. It is the direct measurement of tester accuracy. The OC curve is also a better metric that helps tester users choose the mode of tester operation and minimize costs induced by false calls and escapes.

In one embodiment of the invention, a controlled statistical experimental design is required in data acquisition. In a controlled experiment, samples are randomly chosen to be in treatment groups. For example, in an Automated X-ray Inspection tester, solder joints on a printed circuit board are tested. Solder joints are randomly chosen to be in experiments using sensor A or sensor B. The classification results from the two experiments can then be compared.

In sophisticated testers, there are often many factors which impact classification performance. For example in an imaging system, factors include imaging source, sensor, mechanical parts, connectors and cabling, signal conditioning, analog and digital signal processing algorithms, classification algorithms, etc. Not only will the improvement of each factor impact the system, but also the interaction between factors. For instance, the classification algorithm is highly dependent on feature extraction, i.e. algorithms used to extract numeric values describing the sizes, locations, etc., of various features visually present in the images.

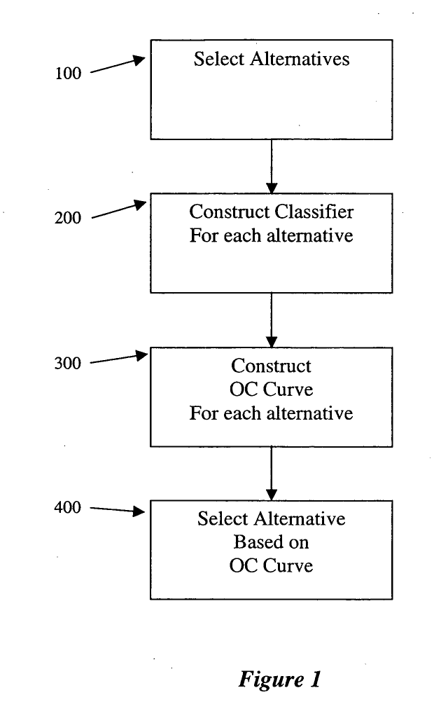

FIG. 1 shows an embodiment of the invention. In step 100, one or more design alternatives are selected. To address interactions properly, factorial design is used.

A factorial design allocates random samples with each level of these factors, as well as of their interactions, simultaneously. As an example, consider a two-factor design for automated X-ray inspection of gullwing-type solder joints, In the data acquisition step, the choice is between sensor A and sensor B. In the image processing step, the choice is between algorithm A and algorithm B. A factorial design randomly allocates gullwing joints into four equal-sized treatment groups: I, II, III, and IV as follows:

| | Sensor A | Sensor B |
|---|---|---|
| Algorithm A | Joints I | Joints II |
| Algorithm B | Joints III | Joints IV |

Experimental data from the four treatment groups can then be used to perform the following comparisons:
a) Compare Sensor A with Sensor B
b) Compare Algorithm A with Algorithm B
c) Compare interactions:
   i. Sensor A coupled with Algorithm A
   ii. Sensor A coupled with Algorithm B
   iii. Sensor B coupled with Algorithm A
   iv. Sensor B coupled with Algorithm B.

According to the present invention, classifiers are constructed in step 200 using the sample data generated in the data acquisition step. Using the preceding example, data from Joints I and III is used to build classifier A, and data from Joints II and IV is used to build classified B. The performance of these two classifiers are then compared to give assessments for Sensor A and Sensor B. We can also build four classifiers to compare and compare the performance of the classifiers to assess the four interactions.

Operating Characteristics curves are constructed for each design alternative in step 300. Each curve relates a single threshold value which is tuned to construct the Operating Characteristics curve.

In step 400, a design alternative is selected using the Operating Characteristics curves. One embodiment combines each Operating Characteristics curve with cost definitions to yield the optimal design decision.

Economic costs of two kinds are introduced:
C1=estimated dollar costs per false call
C2=estimated dollar costs per miss.

The total cost C is defined as:
C=C1 *false call rate*prior probability of good+C2*(1-Sensitivity)*prior probability of bad

If C1=C2, C is defined as the probability of misclassification times the cost per misclassification.

The X-axis is weighted by (C1 *prior probability of good) and the Y axis is weighted by (C2 *prior probability of bad).

Given the weighted axes, compute the sum:
False Call Rate*(Prior probability of good)*C1+(1-Sensitivity)*(Prior probability of bad)*C2

The selected alternative is the point with the smallest sum.

If prior probabilities and costs are not known, estimates may be made based on practical experience.

If there is only one design in the data acquisition step, the procedures presented may still be used to evaluate different classification schemes.

If there is only one factor to be considered in data acquisition, a one-way layout may be used rather than factorial design. A one-way layout randomly assigns samples to two designs. Data are acquired for the two designs, and the procedures described herein used.

The foregoing detailed description of the present invention is provided for the purpose of illustration and is not intended to be exhaustive or to limit the invention to the precise embodiments disclosed. Accordingly the scope of the present invention is defined by the appended claims.

1. A method of selecting a tester design comprising:
selecting one or more design alternatives,
constructing a classifier for each alternative using sample data,
construction Operating Characteristics curves for each classifier, and
selecting a design alternative based on the Operating Characteristic curves.

2. The method of claim 1 where the step of selecting a design alternative further comprises:
weighting each Operating Characteristics curve using cost constraints to form a result, and
selecting the Operating Characteristics curve with the minimal result.

3. The method of claim 1 where classifiers for each alternative are constructed from sample data gathered through data acquisition.

4. The method of claim 3 where data acquisition uses a factorial design when more than one alternative is present.

5. The method of claim 3 where data acquisition uses a one-way layout when only one alternative is present.

6. A computer readable medium that includes executable instructions for processing sequence number information used in communications protocols, said computer readable medium comprising:
code for selecting one or more design alternatives,
code for constructing a classifier for each alternative using sample data,
code for construction Operating Characteristics curves for each classifier, and
code for selecting a design alternative based on the Operating Characteristic curves.

7. The computer readable medium of claim 6 where the code for selecting a design alternative further comprises:
code for weighting each Operating Characteristics curve using cost constraints to form a result, and
code for selecting the Operating Characteristics curve with the minimal result.
